(19) United States
(12) Patent Application Publication
(10) Pub. No.: US 2007/0031084 A1
(43) Pub. Date: Feb. 8, 2007

(54) TRAFIC MONITORING SYSTEM

(75) Inventors: David W. Wang, Saratoga, CA (US); John C. Tsai, Saratoga, CA (US); How Lin, Vestal, NY (US); Le-Heng Wang, San Jose, CA (US)

Correspondence Address: INTELLECTUAL PROPERTY LAW OFFICES, 1901 S. BASCOM AVENUE, SUITE 660, CAMPBELL, CA, 95008, US

(73) Assignee: Fibera, Inc., Santa Clara, CA (US)

(21) Appl. No.: 11/425,392

(22) Filed: Jun. 20, 2006

Related U.S. Application Data
(60) Provisional application No. 60/595,281, filed on Jun. 20, 2005.

(51) Int. Cl. H04B 10/08; G02B 6/34

(52) U.S. Cl. 385/37; 372/46.01; 398/34

(57) ABSTRACT

A system for monitoring traffic across a structure. A fiber Bragg grating (FBG) reflects a light wavelength. A mounting mechanism connects the FBG to the structure, such that physical change of the structure changes a stress to the FBG that changes the light wavelength. And optical fiber carries a first light beam to the FBG and carries a second light beam from the FGB. This permits first light beam including the light wavelength to be received from a light source, and permits the first light beam to be altered into the second light beam by passing the light wavelength through the FBG, and permits the second light beam to be provided to a detector to sense the light wavelength present in the second light beam. From this the stress in the structure and information about the traffic across a structure can be inferred.

### CROSS-REFERENCE TO RELATED APPLICATIONS

This application claims the benefit of U.S. Provisional Application No. 60/595,281, filed 20 Jun. 2005, hereby incorporated by reference in its entirety.

### TECHNICAL FIELD

This invention relates to the use of fiber optic sensors and interrogators for traffic monitoring. Specifically, it teaches the construction and use of such to detect the position, direction, speed, acceleration or deceleration, weight, and axel count of traffic by pedestrians, bicycles, motorcycles, automobile and truck vehicles, trains, etc.

### BACKGROUND ART

Current traffic monitoring systems have a number of drawbacks. A large variety of human and animal (i.e., pedestrian) traffic monitoring systems exist today, but are generally so awkward to use or are so limited to only particular situations that having a human watch traffic and counting passings is still widely resorted to. Where pedestrian traffic can be constricted, turn styles with mechanical or electrical counters are used. Pads sensitive to the pressure of passing traffic have also been used, but are little seen today due to cost, limited robustness, and the little information they actually provide (e.g., such pads poorly detect whether a triggering event is caused by one large adult or two children). Optical beam-break and heat detection systems are also used, but more widely to monitor for pedestrian presence (there verses not there, say, in a monitored doorway) rather than to actually provide detailed information about traffic.

Bicycle and motorcycle traffic are generally monitored using the same techniques, and often the very same systems, as roadway vehicle traffic. [The remarks below about those systems therefore largely apply to this kind of traffic as well.] However, such vehicle monitoring systems are often poorly adapted for bicycle and motorcycle traffic monitoring, and can even fail to be triggered by bicycle or motorcycle traffic.

For the monitoring of vehicle traffic on highways, conductance loop systems are the most common today. Installation of these, however, requires carefully cutting the road surface along significant distances to form multiple roughly circular or square shapes to receive the conductive wire loops. This can leave the road surface weakened and subject to cracking, which can damage or otherwise endanger the traffic using the roadway. The sensor loops employed here are also easily damaged under heavy traffic loads, with some common failure mechanisms including breakage, sensor wire pull-out at connections, and sealant failure under the typical temperature cycles encountered. While the materials, e.g., simple wire loops, may be relatively inexpensive, the labor require to replace them can be considerable and shutting off or diverting roadway traffic while they are repaired or replaced can entail very significant costs. This type of monitoring system generally only provides the limited ability to trigger a vehicle count signal, and it has very limited ability or reliability at detecting light objects, such as humans or animals, bicycles, motorcycles, etc.

Another commonly used method for counting vehicles passing in a roadway is to place a thin gas filled rubber tube across just the portion of the roadway of interest, to sense vehicle weight compressing the tube and thus the gas in it. However, these systems require considerable maintenance, both to repair damage to them caused by heavy traffic and to ensure that they stay well secured to the road surface and do not themselves become a hazard in the roadway.

To determine the weigh of vehicles, highway departments today commonly use scales at roadside weigh stations. This approach has a number of limitations. Obviously, since it is at the roadside rather than in the roadway itself, not all traffic gets weighed. In fact, the use of such systems today is overwhelmingly for weighing commercial vehicles to determine whether they are overloaded or to calculate weight-based payments for taxes or freight sales. The scales used for this are expensive and require extensive construction or set up, and the vehicles weighed need to be stopped while being weighed.

Railway traffic monitoring and signaling systems widely use the track circuit, applying electricity to an insulated rail segment and triggering when the presence of a train shunts the circuit. Although used for many years, this approach is known to require constant maintenance.

It is also limited primarily to use as a presence or passage detection system. It cannot detect the direction, weigh, speed, acceleration, deceleration, axel count, etc. of a train.

Accordingly, an improved traffic monitoring system is needed.

### DISCLOSURE OF INVENTION

Accordingly, it is an object of the present invention to provide an improved traffic monitoring system.

Briefly, one preferred embodiment of the present invention is a system for monitoring traffic across a structure. A fiber Bragg grating (FBG) is provided to reflect a light wavelength, and a mounting mechanism is provided to connect the FBG to the structure such that physical change of the structure changes a stress on the FBG that changes the light wavelength. Optical fiber then carries a first light beam to the FBG and carries a second light beam from the FGB. This permits an instance of the first light beam including the light wavelength to be received from a light source, and permits the first light beam to be altered into the second light beam by passing the light wavelength through the FBG, and permits the second light beam to be provided to a detector to sense the light wavelength present in the second light beam. Stress in the structure and information about the traffic across a structure, can then be inferred.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE DRAWINGS

The purposes and advantages of the present invention will be apparent from the following detailed description in conjunction with the appended figures of drawings in which:

FIG. 1a-b (background art) are before and during schematic depictions of the operation of stress on a fiber Bragg Grating (FBG);

FIG. 2a-b (background art) are schematics of multi-FBG systems, wherein FIG. 2a shows a parallel configuration and FIG. 2b shows a series configuration;

FIG. 3a-b (background art) are schematics of enhanced FGB units, wherein FIG. 3a shows an athermal FBG unit and FIG. 3b shows a force multiplying-dividing FBG unit;

FIG. 4a-b are simplified schematics of multiple FBGs in a flexible plate-based traffic monitoring system in accord with the present invention, wherein FIG. 4a is a side view and FIG. 4b is a top view with the top plate of FIG. 4a removed;

FIG. 5a-c are before, during, and during schematic depictions of an alternate flexible plate-based multi-FBG traffic monitoring system in accord with the present invention;

FIG. 6a-b are before and during schematic depictions of multi-FBG sensor and rubber-pad-based traffic monitoring system in accord with the present invention;

FIG. 7a-b are before and during schematic depictions of a single FBG sensor and rubber-pad-based traffic monitoring system in accord with the present invention;

FIG. 8a-b are before and during schematic depictions of a multi-FBG sensor and tensed cable with rubber-pad-based traffic monitoring system in accord with the present invention;

FIG. 9a-c are before, during, and during schematic depictions of a tensed cable and flexible plate-based multi-FBG sensor traffic monitoring system in accord with the present invention; and

FIG. 10a-b are graphs of representative data from two embodiments of traffic monitoring systems in accord with the present invention, wherein FIG. 10a shows FBG response to the passage of a mini-van and FIG. 10b shows FBG response to the passage of a railroad train.

### BEST MODE FOR CARRYING OUT THE INVENTION

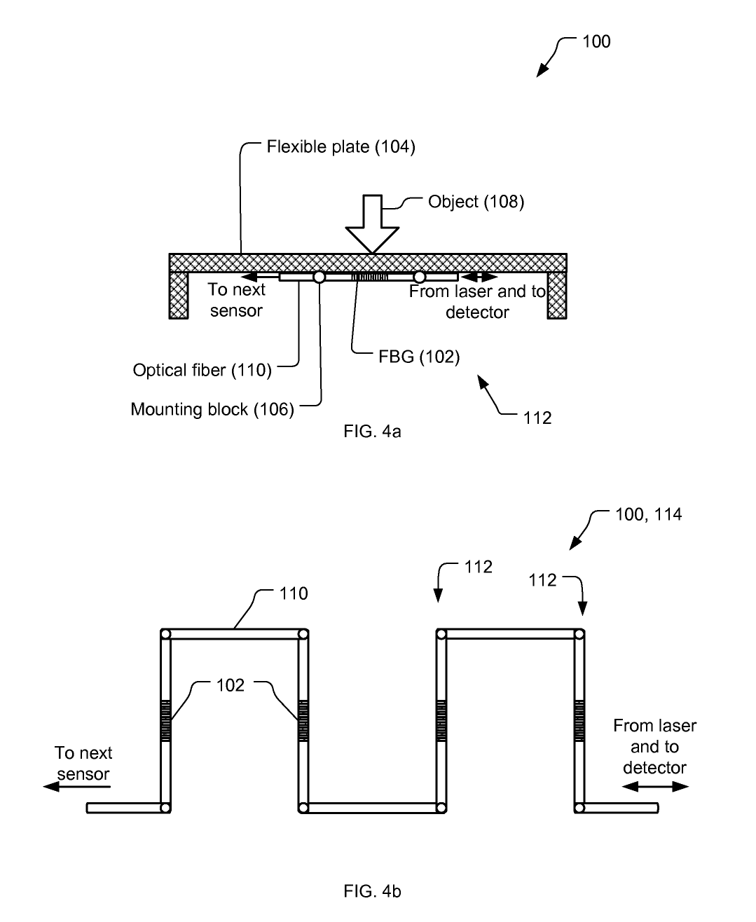

A preferred embodiment of the present invention is a fiber Bragg grating (FBG) based traffic monitoring system. As illustrated in the various drawings herein, and particularly in the view of FIGS. 4a-b, 5a-c, 6a-b, 7a-b, 8a-b, and 9a-c, preferred embodiments of the invention are depicted by the general reference character 100.

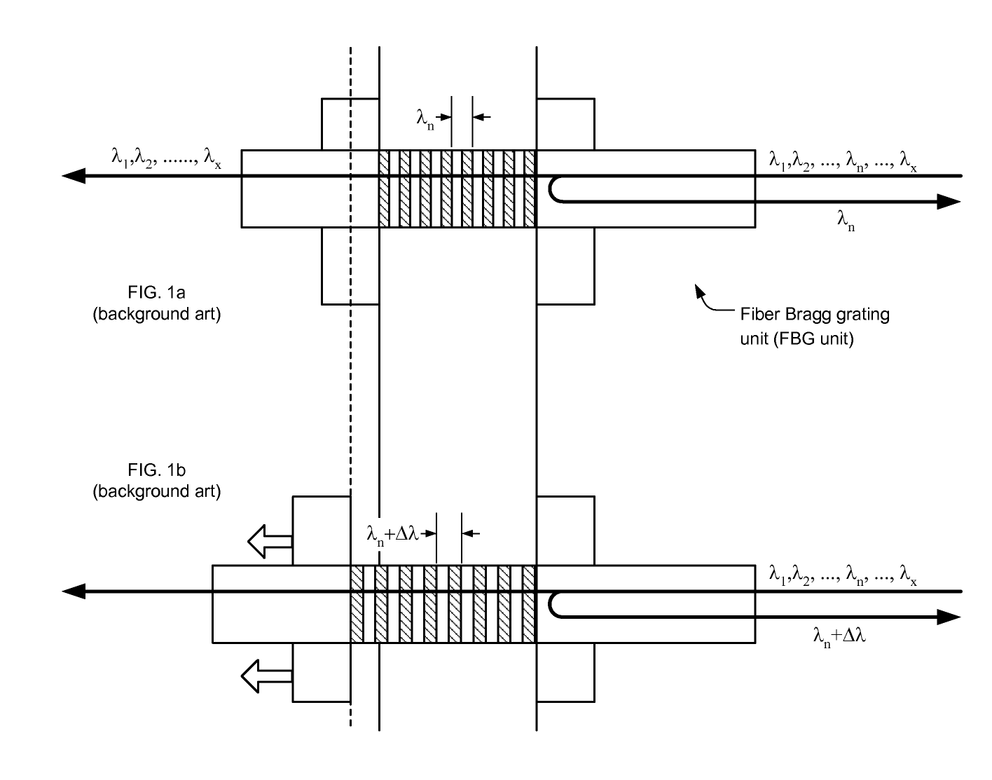

Briefly, this invention uses FBG sensors and data collecting systems to monitor traffic. FIG. 1a-b (background art) are before and during schematic depictions of the operation of stress generally on a fiber Bragg Grating (FBG). Briefly, the ends of the FBG are secured so that strain changes their separation, and thus stresses the FBG. In the characteristic manner of a FBG, this changes the light wavelength that the FBG reflects (from λₙ to λₙ+Δλ).

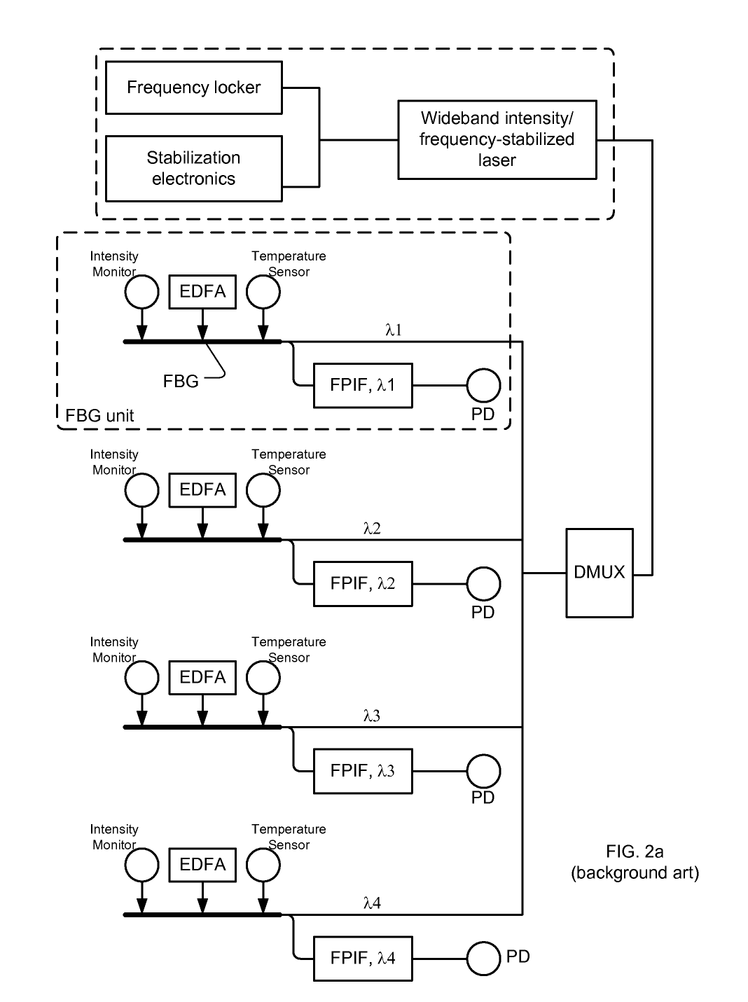

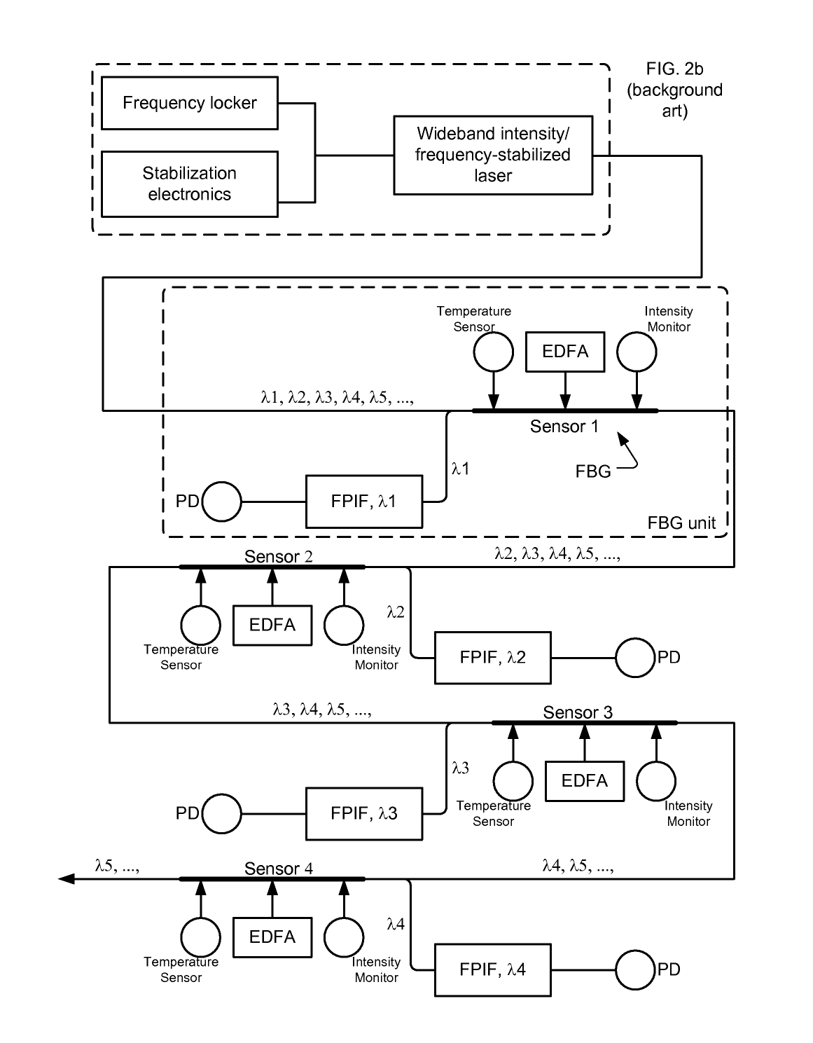

FIG. 2a-b (background art) are schematics of parallel and series multi-FBG systems, respectfully. In FIG. 2a a wideband light source provides light having suitable wavelengths to a multiplexer/demultiplexer (DMUX), which passes it onward to a plurality of parallel FBG units. The FBG units particularly shown here are sophisticated units, which may be more than is needed in many applications. These FBG units are temperature and light intensity corrected and have internal erbium-doped fiber amplifiers (EDFA). Each FBG unit includes its own Fabry-Perot interference filter (FPIF) and photodetector (PD). In FIG. 2b a wideband light source provides light having suitable wavelengths to a plurality of serial FBG units.

It is known in the art that FBG-type fiber optic sensors can be used to sense deformation in a stationary structure by detecting the shift in the wavelength of reflective light. However, even this is known to have many drawbacks. Two major examples of such are the following.

The accuracy of a FBG signal (i.e., the reflective wavelength of the device) is strongly affected by temperature. This therefore usually requires the use of another device, placed close to the first but not subject to deformation, to permit applying differential-based signal processing techniques to cancel the effects of temperature on the other “working” FBG sensor. This approach adds to the cost in many respects, doubling the number of sensors as well as the processing channels of the interrogator system used, and reducing the interrogator's processing efficiency. FIG. 2a-b include alternate approaches to dealing with this problem.

In general, FBG sensors are fragile and must be handled with care to avoid damage, especially in the initial construction environment and to ensure that they are not damaged after installation by the traffic load. Various schemes exist to deal with this, and some particular ones are discussed further, below.

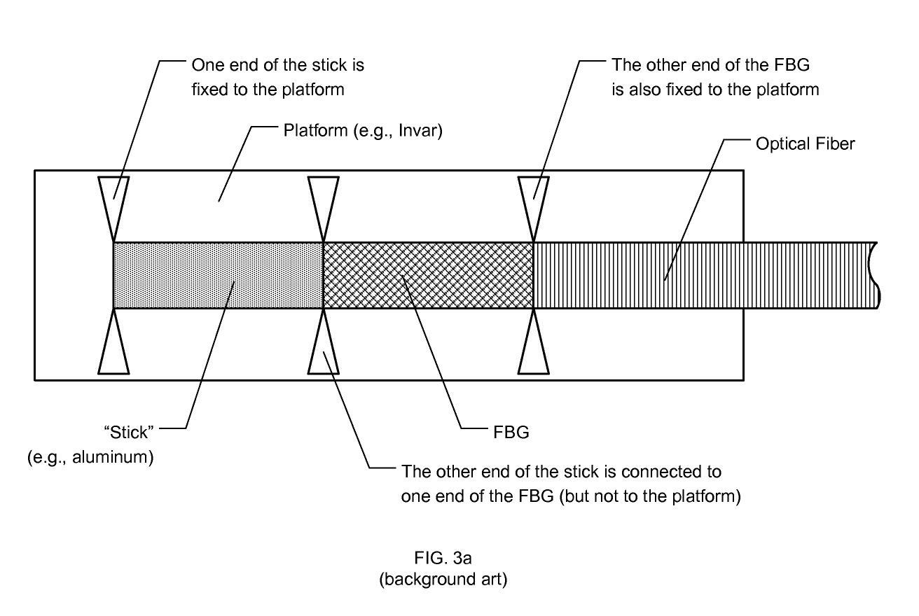

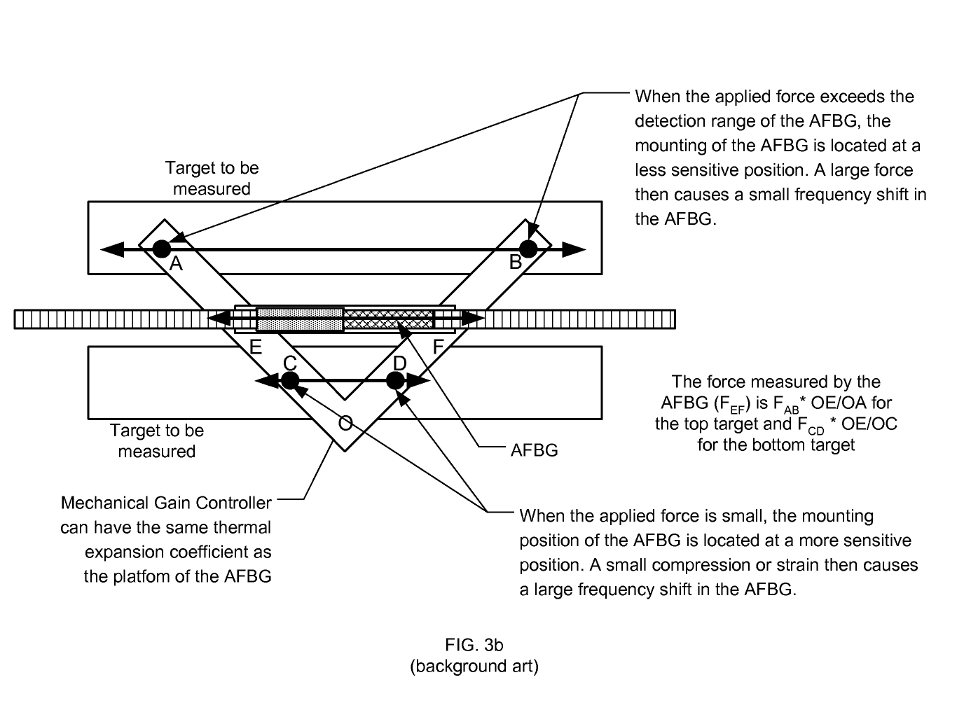

FIG. 3a-b (background art) are schematics of enhanced FGB units that have features that overcome or reduce the traditional problems encountered with FBG-based sensors, and thus make them particularly suitable for use in embodiments of the present invention. FIG. 3a shows an athermal unit, wherein thermal effects on the critical FGB zone are offset by thermal effects in other materials used in the overall device. FIG. 3b shows a mechanical force multiplying-dividing FBG unit. This enhancement permits “tuning” FBG units to traffic monitoring applications better, as well as reducing the variety of FBG units that have to be manufactured or stocked.

FIG. 4a-b are simplified schematics of a series multi-FBG embodiment of a traffic monitoring system 100 in accord with the present invention. As can be seen in FIG. 4a, basically, one or more FBGs 102 are mounted below a flexible plate 104, typically between mounting blocks 106 as shown. As an object 108 (i.e., “traffic” when the object 108 is moving) passes its weight flexes the plate 104, and then stresses the FBGs 102 accordingly. As described above in the background art section, the FBG 102 or FBGs 102 are incorporated into or used with optical fiber 110 that carries light beams from one or more light sources (not shown here, e.g., a laser), between multiple such FBG-based sensors 112, and onward to one or more detectors (not shown here, e.g., a photodiode).

FIG. 4b is a top view with the flexible plate 104 of FIG. 4a removed, to more clearly show a serial arrangement 114 of such FBG-based sensors 112 and of the FBGs 102 in them the and optical fiber 110 between them.

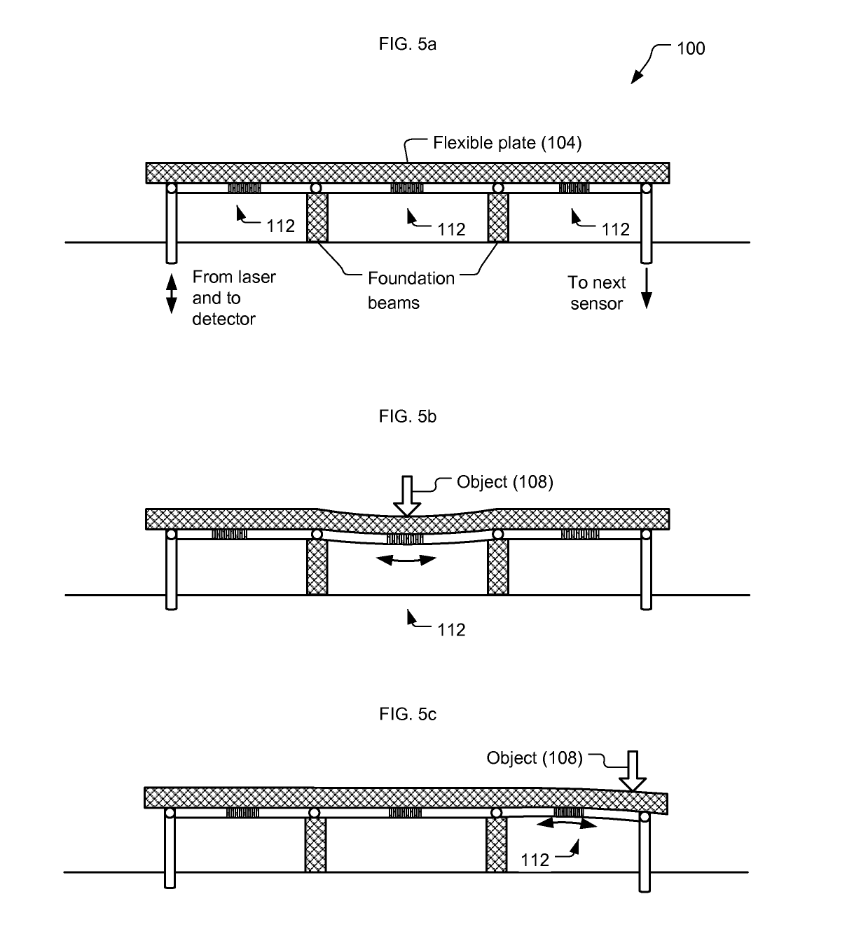

FIG. 5a-c are before, during, and during schematic depictions of an alternate flexible plate-based multi-FBG traffic monitoring system 100. Here it can be seen that localized deformation of the flexible plate 104 can easily be detected. FIG. 5a shows three FBG-based sensors 112 under a flexible plate 104 that is unaffected by the weight of any objects (e.g., traffic). FIG. 5b then shows what happens when an object 108 is introduced above the center of the plate, and thus above the centermost FBG-based sensor 112 here, and FIG. 5c shows what happens when an object 108 is introduced above the right edge of the plate, and thus above the rightmost FBG-based sensor 112 shown here. The object 108 in FIG. 5c can be a different one than the object 108 in FIG. 5b or it can be the same one, only now moved.

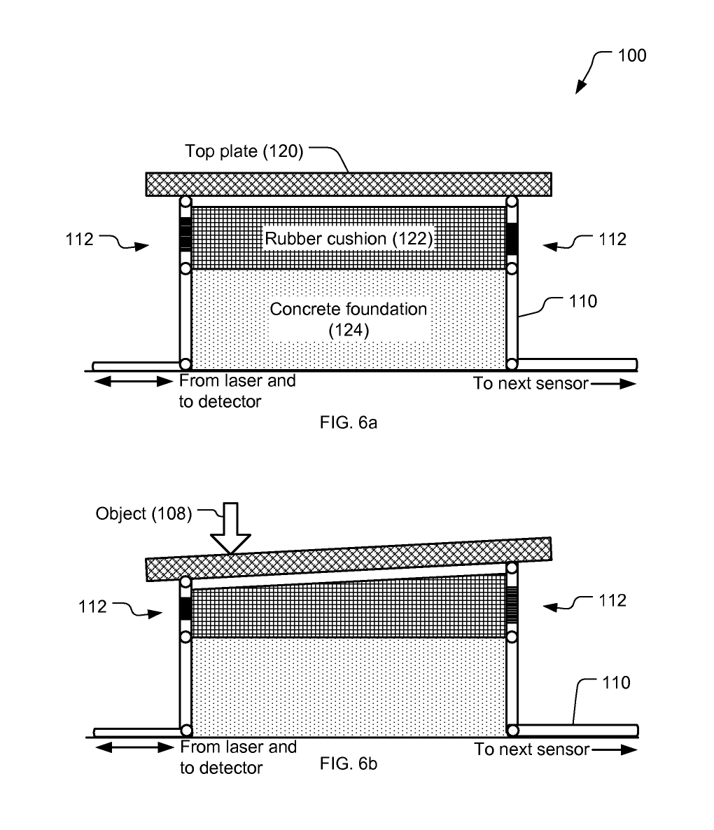

FIG. 6a-b are before and during schematic depictions of another traffic monitoring system 100 in accord with the present invention. Here the top plate 120 is presumably rigid and deforms a rubber (compressible) pad 122 resting on a foundation 124, to operate any of multiple FBG-based sensors 112. Note, although only two FBG-based sensors 112 are shown here, an arrangement like that of FIG. 4b is also easily usable.

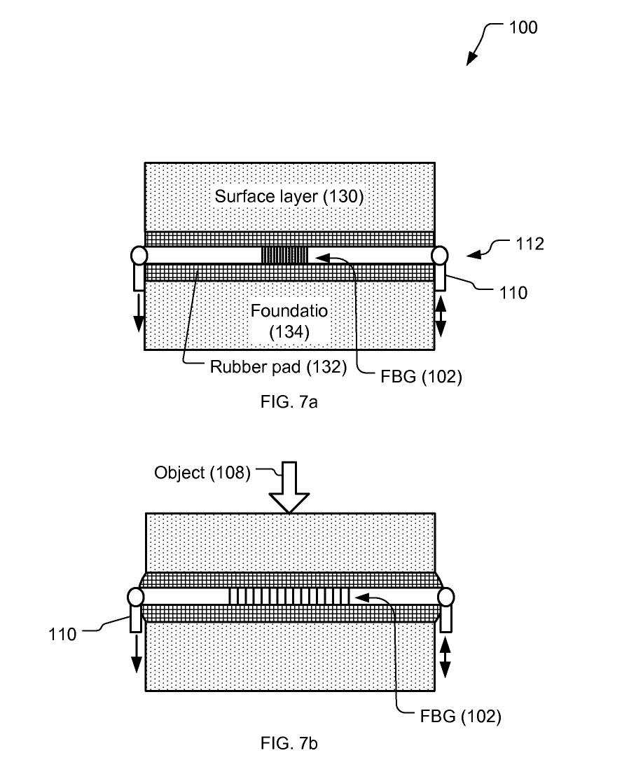

FIG. 7a-b are before and during schematic depictions of another compressible-pad-based traffic monitoring system 100. Here a surface layer 130 (possibly itself being somewhat flexible or rigid) rests above a rubber pad 132 that encases a FBG-based sensor 112, and that optionally rests atop a foundation 134. The surface layer 130 and the foundation 134 conceptually function much like the plate 120 and the foundation 124 in FIG. 6a-b. The compressible pad 132 here, however, operates differently. Rather than employ just vertical compression, the rubber pad 132 here employs horizontal expansion to stress the FBG 102. In embodiments of the traffic monitoring system 100 like this one it is even possible to dispense with any formal element equivalent to the mounting block 106 of the FBG-based sensor 112 in FIG. 4a. If the pad 132 itself grips the FBG 102 securely enough, the stress from an object 108 here will still be transferred to the FBG 102.

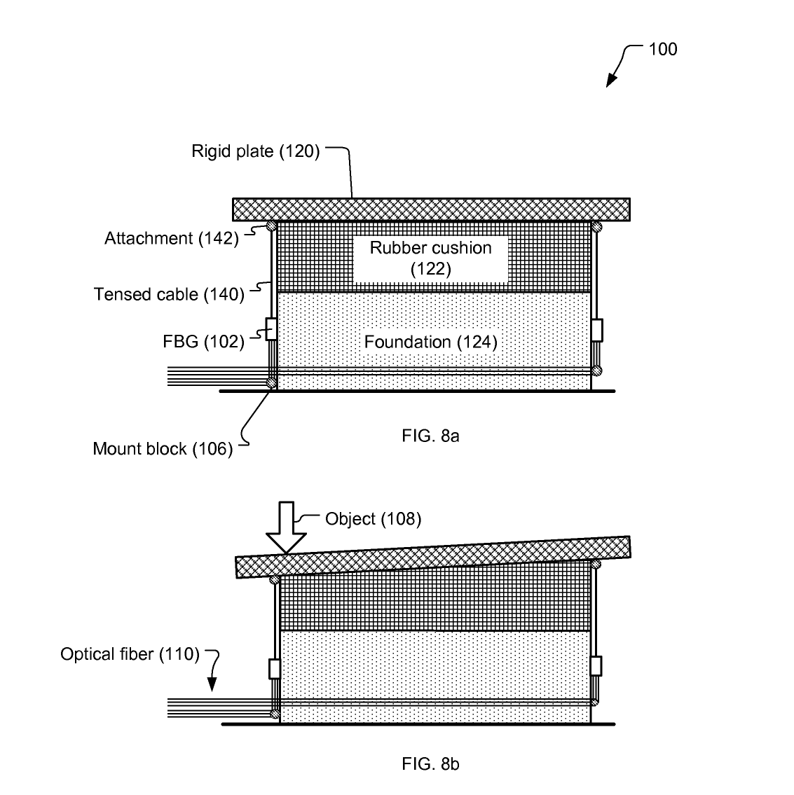

FIG. 8a-b are before and during schematic depictions of a multi-FBG tensed cable and rubber-pad-based traffic monitoring system 100. Here an FBG 102 is integrated with or connected with one end of an optical fiber 110 that is held fixed by a mounting block 106. The other end of this assembly is connected to a cable 140 that is connected at an attachment block 142 mounted on a top plate 120, as shown. The top plate 120 rests atop a rubber pad 122, resting in turn atop an optional foundation 124. The cable 140 is held stressed (e.g., by a spring in the attachment block 142 or by any other mechanism) so the FBG 102 in the FBG-based sensor 112 is held pre-stressed. When an object 108 (e.g., traffic) weighs upon the plate 120 and compresses the underlying pad 122 the stress on the FBG 102 is reduced, which can be detected and responded to as desired. Of course, other mechanisms to stress the FBGs 102 besides the cable 140 may be substituted, for instance, a coil spring.

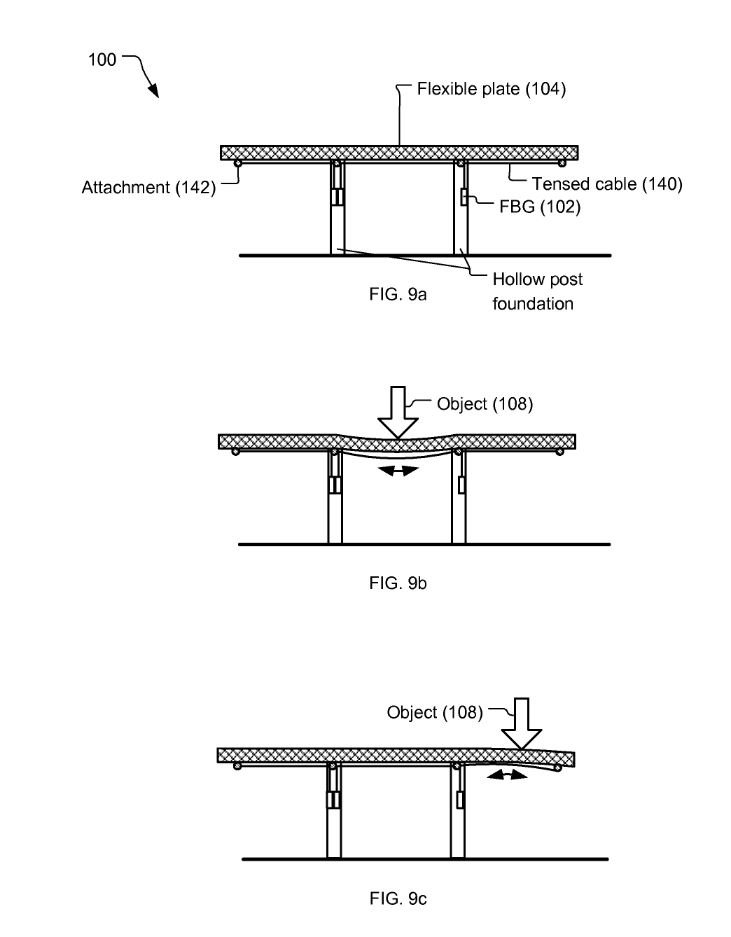

FIG. 9a-c are before, during, and during schematic depictions of a traffic monitoring system 100 using this tensed cable approach as well as the previously depicted flexible plate-based approach. Here cable 140, attachment blocks 142, and FBGs 102 (and mounting blocks 106 and optical fiber 110, etc., not shown) are mounted below a flexible plate 104 as shown. In operation, this embodiment of the inventive traffic monitoring system 100 operates much like that in FIG. 5a-c. The weight of an object 108 (or objects 108, plural) deforms the plate 104 (at one or more locations), thus changing the stress on one or more of the cables 140 and accordingly changing the stress on the one or more corresponding FBGs 102.

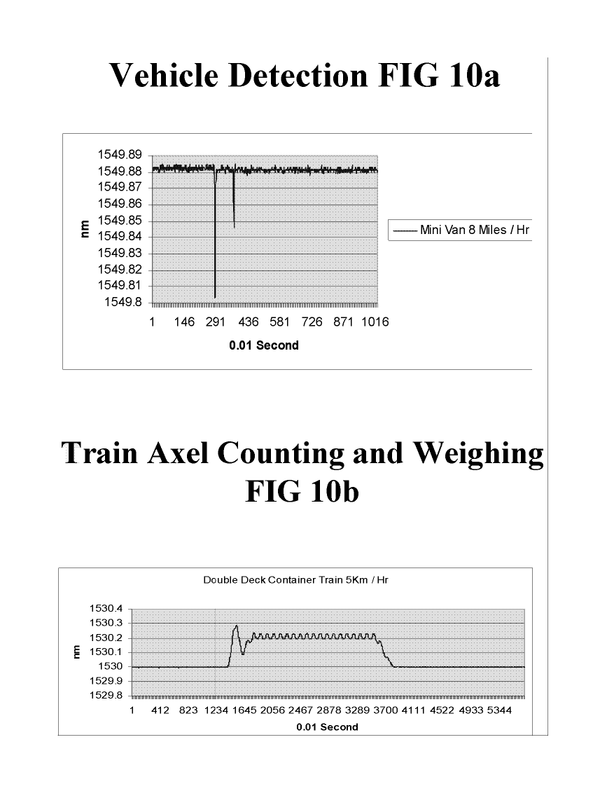

FIG. 10a-b are graphs of representative data from two embodiments of traffic monitoring systems 100 in accord with the present invention. FIG. 10a shows the response of an FBG 102 in a FBG-based sensor 112 to a mini-van passing at 8 miles per hour. The FBG-based sensor 112 used here was mounted on a pavement surface (e.g., below the surface layer 130 in FIG. 7a-b), but there are many other possible straightforward configurations. The van used for this particular experiment had the rear bench removed and carried no cargo or passengers. It can be clearly seen that the weight at the front of the van (the object 108 “seen” at one instant in time) here was substantially more than at the rear of the van (the object 108 “seen” at another instant in time).

FIG. 10b shows the response of the FBG 102 to the passage at 5 kilometers per hour of the individual axels of a train loaded with containers in a double-deck manner (i.e., a scenario wherein each axel is seen as an object 108 at different instant in time). The data in this figure was collected at a bridge structure, but the FBG-based sensor 112 could easily instead have been directly attached to the track or tie bar, sleeper, bridge structure, slab. etc.

Closer study of FIG. 10a-b provides interesting detail about the particular traffic encountered. Coupled with information from other sensors in the same traffic monitoring system 100, or even from a number of traffic monitoring systems 100, it can be appreciated that yet more information can be obtained. For example, the “dips” in FIG. 4a can represent the passage of a single, two-axel vehicle. If one then knows the vehicle speed, it is a simple matter to calculate the axel separation. Conversely, if one knows the axel separation, the actual speed can be calculated. For common vehicle traffic having such “givens” is unlikely, but this data can still be quite useful when accumulated. For instance, a civil engineer could use a traffic monitoring system 100 like that used for FIG. 10a to determine the averages and the ranges of both mechanical stress frequency and amplitude at a bridge, and thus to see how close actual traffic conditions are to the design capacity of the bridge and to its inherent resonant mechanical frequency. A border agent could use the traffic monitoring system 100 of FIG. 10a to look for abnormal differences in front verses rear axel weights of vehicles, perhaps caused by contraband passengers in a closed compartment or by contraband substances secreted behind panels. Of course, detecting traffic where there is not supposed to be traffic, say, after closing hours, can also be useful for detecting trespassers.

By looking at FIG. 10b it can now be appreciated that the train there had a single engine-car pulling rather than pushing the other cars of the train. Also, since axel separation on rail cars is generally standardized, train speed can be determined directly from the graph. Although not a case represented in FIG. 10b, for a vehicle or vehicle system with so many axels it is even possible to determine acceleration or deceleration to some extent from the similar graph elements.

With two FBG-based sensors 112 in a traffic monitoring system 100, determining the speed of traffic becomes easy, and by adding a third or more FBG-based sensors 112, whether traffic is accelerating or decelerating, and at what rate can all be determined. Furthermore, much of this can be determined essentially simultaneously.

The figures herein have already depicted a number of aspects of FBG-based traffic monitoring systems 100 in accord with the present invention. The inventors have a number of design preferences as well. For roadway traffic monitoring, for instance, one preferred approach is to use a FBG-based sensor 112 wherein the FBG 102 is packaged in a highly rigid housing which is then attached to a tubular member or to a solid piece of rod, with openings allowing mounting to a monitored structure. Many types of tubular and rod materials can be used, such as metal, plastics, rubber, and fiber reinforced composites. To provide durability and reliability under heavy traffic conditions, a steel tube is preferred. This allows certain advantages which include ease of installation in the field, and either surface mounting or burying. As effective load transfer is an important factor for achieving reliable results, a mounting bracket can be included in the sensor tube or rod cavities. To protect from moisture or other liquid penetration, a tube can also be filled with liquid or soft materials.

One exemplary traffic monitoring system 100 that the inventors have worked with uses a 2″×1″×4′ steel tube to house the FBG-based sensors 112. A square of rectangular tube or bar is easy to fabricate, but other shapes are also useful. Various mechanical apparatus can also be used to adjust sensitivity, such as anchoring a “C” or “V” shaped tube to the body of the sensor device (see e.g., FIG. 3b). Although less preferred, the FBGs 102 can be attached on the outside surface of a tubular member. Depending on the mounting method used, a single device can provide signals either in tension or compression mode (see e.g., FIGS. 6a-b and 8a-b).

For many applications, the preferred FBG-based sensors 112 are athermal in nature (see e.g., FIG. 3a). Due to its insensitivity to temperature, athermal units are particularly useful in many situations and give the best signal to noise ratio. In some applications, however, athermal characteristics may not be necessary.

A single or a plurality of FBGs 102 can be included in a single FBG-based sensor 112 used for traffic monitoring. When a plurality of FBG-based sensors 112 are installed in a roadway path, the load of a pedestrian or vehicle will trigger responses which can be monitored by a single interrogator. Data collected from such a plurality of FBG-based sensors 112 within one traffic monitoring system 100 is useful in the manners already discussed. With modern communications, data recording, and data analyzing capabilities, the data collected from a plurality of different traffic monitoring systems 100 becomes even more useful. For instance, a suburb expecting traffic growth can employ statistical data about traffic growth rates in comparable areas to justify budget requests or tax initiatives.

While various embodiments have been described above, it should be understood that they have been presented by way of example only, and that the breadth and scope of the invention should not be limited by any of the above described exemplary embodiments.

What is claimed is:

1. A system for monitoring traffic across a structure, comprising:
a fiber Bragg grating (FBG) to reflect a light wavelength;
a mounting mechanism to connect said FBG to the structure such that physical change of the structure changes a stress to said FBG that changes said light wavelength;
optical fiber to carry a first light beam to said FBG and to carry a second light beam from said FGB, thereby permitting a said first light beam including said light wavelength to be received from a light source, permitting said first light beam to be altered into said second light beam by passing said light wavelength through said FBG, and permitting said second light beam to be provided to a detector to sense said light wavelength present in said second light beam and there from infer said stress in the structure and there from infer information about the traffic across a structure.
